(19) United States
(12) Patent Application Publication
(10) Pub. No.: US 2020/0372104 A1
(43) Pub. Date: Nov. 26, 2020

(54) METHODS, SYSTEMS, APPARATUSES AND DEVICES FOR FACILITATING BOOK FORMATTING

(71) Applicant: Calix L. No Surname, Lancaster, CA (US)

(72) Inventor: Calix L. No Surname, Lancaster, CA (US)

(21) Appl. No.: 16/543,080

(22) Filed: Aug. 16, 2019

Related U.S. Application Data
(60) Provisional application No. 62/852,635, filed on May 24, 2019.

(51) Int. Cl. G06F 17/24; G06F 17/21; G06F 16/953; G06F 9/451

(52) U.S. Cl. CPC G06F 17/248; G06F 9/451; G06F 16/953; G06F 17/211

(57) ABSTRACT

Disclosed herein is a system for facilitating book formatting. Accordingly, the system may include a communication device configured for receiving a request to perform one or more book formatting operations from a user device. Further, the communication device may be configured for transmitting a plurality of queries to the user device based on the request. Further, the communication device may be configured for receiving a plurality of responses corresponding to the plurality of queries from the user device. Further, the system may include a processing device configured for analyzing the plurality of responses to identify one or more templates stored in a template database. Further, the processing device may be configured for generating a distributor ready digital book based on the one or more templates. Further, the system may include a storage device configured for retrieving the one or more templates from the template database based on the analyzing.

The current application claims a priority to the U.S. Provisional Patent application Ser. No. 62/852,635 filed on May 24, 2019.

### FIELD OF THE INVENTION

Generally, the present disclosure relates to the field of data processing. More specifically, the present disclosure relates to methods, systems, apparatuses and devices for facilitating book formatting.

### BACKGROUND

The field of book formatting and designing is important to several organizations and/or individuals (such as authors and publishers) in order to create any kind of book and/or magazine to share in both print and digital formats.

However, existing techniques for book formatting and designing are deficient with regard to several aspects. For instance, current technologies do not provide a remote platform that may ask queries from a user to create the book and/or magazine for the user based on the user's responses.

Therefore, there is a need for improved methods, systems, apparatuses and devices for facilitating book formatting that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating book formatting, in accordance with some embodiments. Accordingly, the method may include receiving, using a communication device, a request to perform one or more book formatting operations from a user device. Further, the method may include transmitting, using the communication device, a plurality of queries to the user device based on the request. Further, the method may include receiving, using the communication device, a plurality of responses corresponding to the plurality of queries from the user device. Further, the method may include analyzing, using a processing device, the plurality of responses to identify one or more templates in a plurality of templates stored in a template database. Further, the method may include retrieving, using a storage device, the one or more templates from the template database based on the analyzing. Further, the method may include generating, using the processing device, a distributor ready digital book based on the one or more templates.

Further disclosed herein is a system for facilitating book formatting, in accordance with some embodiments. Accordingly, the system may include a communication device configured for receiving a request to perform one or more book formatting operations from a user device. Further, the communication device may be configured for transmitting a plurality of queries to the user device based on the request. Further, the communication device may be configured for receiving a plurality of responses corresponding to the plurality of queries from the user device. Further, the system may include a processing device configured for analyzing the plurality of responses to identify one or more templates in a plurality of templates stored in a template database. Further, the processing device may be configured for generating a distributor ready digital book based on the one or more templates. Further, the system may include a storage device configured for retrieving the one or more templates from the template database based on the analyzing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system for facilitating book formatting, in accordance with some embodiments.

FIG. 3 is a flowchart of a method for facilitating book formatting, in accordance with some embodiments.

FIG. 4 is a flowchart of a method for facilitating book formatting for a manuscript, in accordance with some embodiments.

FIG. 5 is a flowchart of a method for facilitating accessing a stored digital book, in accordance with some embodiments.

FIG. 6 is a flowchart of a method to facilitate editing a stored digital book, in accordance with some embodiments.

FIG. 7 is a flowchart of a method to facilitate interior book formatting and design for authors, publishers, and other professionals, in accordance with some embodiments.

FIG. 8 is a flowchart of a method to facilitate viewing previously completed book, in accordance with some embodiments.

FIG. 9 is a flowchart of a method to facilitate editing a previously completed book, in accordance with some embodiments.

FIG. 10 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of book formatting, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

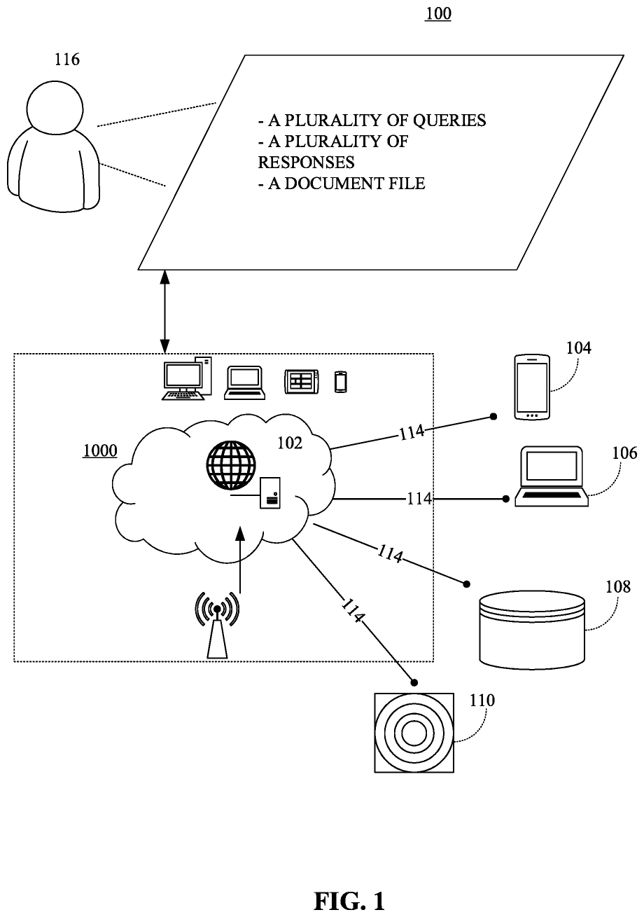

FIG. 1 is an illustration of an online platform 100 consistent with various embodiments of the present disclosure. By way of non-limiting example, the online platform 100 to facilitate book formatting may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 1000.

In some embodiments, the online platform 100 may be configured to facilitate interior book formatting and design for authors, publishers, and other professionals. Accordingly, the interior book formatting and design, in an instance, may include arranging and/or putting one or more book formatting variables together in order to generate a formatted file that may adhere to distributor guidelines. Further, the one or more book formatting variables, in an instance, may include, but not limited to, book format type (Paperback, Hardback, eBook, etc.), distributor name (e.g. IngramSpark, LuLu, CreateSpace/KDP, Lightning Source, Baker & Taylor etc.), genre type (e.g. Sci-Fi, Non-Fiction, Fantasy, Romance, Horror/Thriller), book size (e.g. 178×111 mm, 210×148 mm, 297×210 mm, 203×127 mm, etc.), and so on. Further, the formatted file generated by the online platform 100 based on the one or more book formatting variables, in an instance, may be a formatted pdf and/or word file that may be extracted by the user.

Further, the online platform 100, in an instance, may be configured to provide a user interface for a web-based application that may be operated by a user (such as an author, publisher, and/or other professional) through one or more user devices. Further, the one or more user devices may include devices such as, but not limited to, smartphones, computer tablets, laptops, smart watches, and so on. Further, the one or more user devices may be configured to communicate over a communication network such as, but not limited to, a cellular network, a satellite network, a personal area network, Bluetooth, Internet and so on.

Further, the web-based application may be used by the user (such as an author), where the user may send, with a push of a button, a request to perform one or more functions with regard to book formatting. For instance, the one or more functions may include, but not limited to, formatting a new book, completing an unfinished book, accessing a completed book, and editing a completed book. Further, the web-based application, in an instance, may be used by the user, where the user may provide, with a push of a button, the one or more book formatting variables (such as, but not limited to, book size, genre type, etc.) to the online platform 100 in order to perform the one or more functions, for instance, formatting a new book.

Further, in some embodiments, the web based application may allow the user to save the one or more book formatting variables associated with a book in a database (such as the database 108) and/or a personal cloud storage system. For instance, while formatting a new book, the one or more book formatting variables provided by the user for the new book may be saved (for e.g. auto-saved after each selection) in the database 108 and/or a personal cloud storage system.

Further, the online platform 100 may allow users to create user profiles on the online platform 100. For instance, user profiles may include author profiles, publisher profiles, other professional profiles, and administrator profiles. The user profiles, in an instance, may include information about the users, such as name, age, gender, location, and so on. Further, all personal information other than the name of the user, in an instance, may be anonymous and/or may not be shared. Further, the online platform 100, in an instance, may be configured to verify the information provided by the user by retrieving information from one or more databases. Further, the one or more databases may include at least one of government verified databases (such as, but not limited to, Department of Motor Vehicles), educational institution databases, and medical databases (e.g. Electronic Health Records). Further, administrator profiles may include administrative privileges, such as viewing profile information related to one or more users, allow one or more users to join, and so on, and may correspond to one or more departments.

Further, in some embodiments, the user interface, in an instance, may allow the user to access a completed book (and/or document file). For instance, when the user may select a completed book file, the online platform 100 may retrieve the completed book file from the database 108 and/or may transmit the completed book file to the user device. Further, the user interface, in an instance, may allow the user to view previously completed book and/or may allow the user to re-extract previously completed book.

Further, in some embodiments, the user interface, in an instance, may allow the user to complete an unfinished book (and/or document file). For instance, when the user may select an unfinished book file, the online platform 100 may retrieve the unfinished book file from the database 108 and/or may transmit the plurality of queries where the user left last time.

Further, in some embodiments, the user interface, in an instance, may allow the user to edit a completed book (and/or document file). For instance, when the user may select a completed book file for editing, the online platform 100 may retrieve the completed book file from the database 108. Further, the user interface, in an instance, may allow the user to edit any section of previously completed book, resave, and extract.

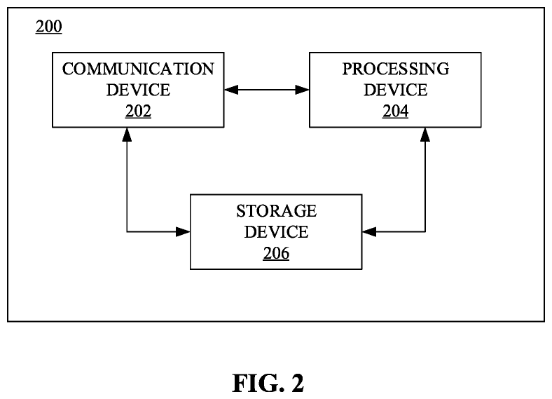

FIG. 2 is a block diagram representation of a system 200 for facilitating book formatting, in accordance with some embodiments. Accordingly, the book formatting, in an instance, may include an arrangement of at least one book formatting variable to generate a distributor ready digital book that adheres to a plurality of distributor guidelines. Further, the at least one book formatting variable, in an instance, may include (but not limited to) a book format type, a distributor name, a genre type, and a book size, etc. Further, the system 200 may include a communication device 202 configured for receiving a request to perform one or more book formatting operations from a user device. Further, in some embodiments, the one or more book formatting operations may include at least one of formatting a new book, completing an unfinished book, accessing a completed book, and editing a completed book.

Further, the communication device 202 may be configured for transmitting a plurality of queries to the user device based on the request. Further, in some embodiments, the plurality of queries may include at least one of a textual query (in a textual form), a visual query (for e.g. showing an image, or visual representation, etc.), an audio query, and an audiovisual query.

Further, the communication device 202 may be configured for receiving a plurality of responses corresponding to the plurality of queries from the user device. Further, the plurality of responses may include at least one of a textual input (in a textual form), an audible input (for e.g. a voice), and a multimedia input (for e.g. uploading a document file).

Further, the system 200 may include a processing device 204 configured for analyzing the plurality of responses to identify one or more templates in a plurality of templates stored in a template database. Further, the template database, in an instance, may sometimes be referred to as Emper's Athanaeum (Library of templates).

Further, the processing device 204 may be configured for generating a distributor ready digital book based on the one or more templates.

Further, the system 200 may include a storage device 206 configured for retrieving the one or more templates from the template database based on the analyzing.

Further, in some embodiments, the transmitting of the plurality of queries may be based on a predefined sequential order. Further, the predefined sequential order, in an instance, may be based on the plurality of responses received from the user device. Further, the predefined sequential order, in an instance, may include one by one provisioning of queries to the user device.

Further, in some embodiments, the template database may include the plurality of templates based on a plurality of genres. Further, the plurality of genres, in an instance, may include genres such as (but not limited to) Sci-Fi, Non-fiction, fantasy, romance, horror/thriller, teen/young adult, action/adventure, crime/mystery etc. Further, in some embodiments, each template in the plurality of templates may include schemas based on a genre in the plurality of genres. For instance, the schemas may include (but not limited to) Number of acts, plot points, structure of each act (exposition, rising action, climax, falling action, resolution), Narrative structure, chapters, transitions between chapters/acts, images, and so on.

Further, in some embodiments, the communication device 202 may be configured for receiving at least one raw manuscript from the user device. Further, the processing device 204 may be configured for structuring the at least one raw manuscript based on the schemas associated with the one or more templates.

Further, in some embodiments, the communication device 202 may be configured for receiving a search request from the user device to access at least one stored digital book. Further, in some embodiments, the at least one stored digital book may include at least one of at least one previously completed digital book, and at least one unfinished digital book. Further, the communication device 202 may be configured for transmitting the at least one stored digital book to the user device. Further, the storage device 206 may be configured for retrieving the at least one stored digital book from a database based on the search request.

Further, in some embodiments, the communication device 202 may be configured for receiving an edit request for the at least one stored digital book from the user device.

Further, the communication device 202 may be configured for transmitting an editing user interface to the user device based on the edit request. Accordingly, the user interface, in an instance, may be an interface that may provide one or more editing tools to the user in order to edit a previously completed book file. Further, the user interface, in an instance, may allow the user to edit any section of the previously completed book file, to resave, and/or to extract the previously completed book file.

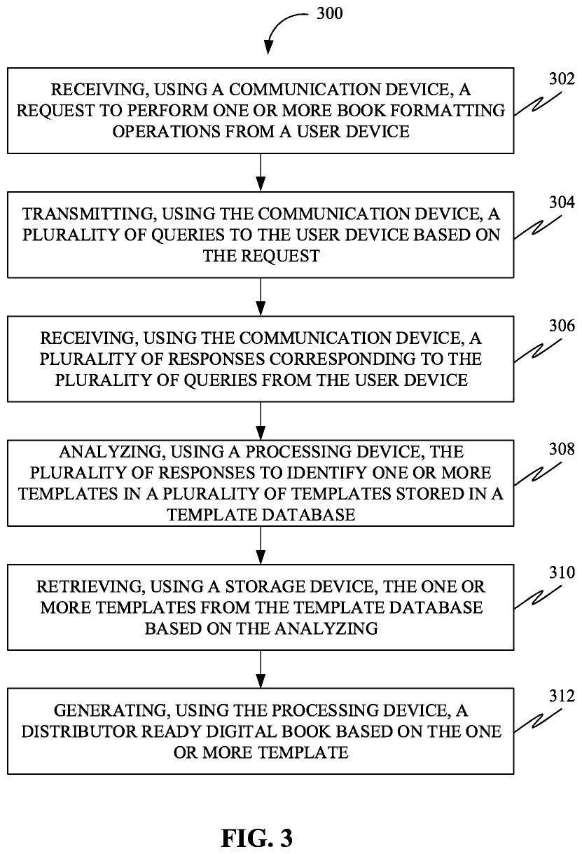

FIG. 3 is a flowchart of a method 300 for facilitating book formatting, in accordance with some embodiments. Accordingly, the book formatting, in an instance, may include an arrangement of at least one book formatting variable to generate a distributor ready digital book that adheres to a plurality of distributor guidelines. Further, the at least one book formatting variable, in an instance, may include (but not limited to) a book format type, a distributor name, a genre type, and a book size, etc. Further, at 302, the method 300 may include receiving, using a communication device (such as the communication device 202), a request to perform one or more book formatting operations from a user device. Further, in some embodiments, the one or more book formatting operations may include at least one of formatting a new book, completing an unfinished book, accessing a completed book, and editing a completed book.

Further, at 304, the method 300 may include transmitting, using the communication device, a plurality of queries to the user device based on the request. Further, in some embodiments, the plurality of queries may include at least one of a textual query (in a textual form), a visual query (for e.g. showing an image, or visual representation, etc.), an audio query, and an audiovisual query.

Further, at 306, the method 300 may include receiving, using the communication device, a plurality of responses corresponding to the plurality of queries from the user device. Further, the plurality of responses may include at least one of a textual input (in a textual form), an audible input (for e.g. a voice), and a multimedia input (for e.g. uploading a document file).

Further, at 308, the method 300 may include analyzing, using a processing device (such as the processing device 204), the plurality of responses to identify one or more templates in a plurality of templates stored in a template database. Further, the template database, in an instance, may sometimes be referred to as Emper's Athanaeum (Library of templates).

Further, at 310, the method 300 may include retrieving, using a storage device (such as the storage device 206), the one or more templates from the template database based on the analyzing.

Further, at 312, the method 300 may include generating, using the processing device, a distributor ready digital book based on the one or more templates.

Further, in some embodiments, the transmitting of the plurality of queries may be based on a predefined sequential order. Further, the predefined sequential order, in an instance, may be based on the plurality of responses received from the user device. Further, the predefined sequential order, in an instance, may include one by one provisioning of queries to the user device.

Further, in some embodiments, the template database may include the plurality of templates based on a plurality of genres. Further, the plurality of genres, in an instance, may include genres such as (but not limited to) Sci-Fi, Non-fiction, fantasy, romance, horror/thriller, teen/young adult, action/adventure, crime/mystery, etc. Further, in some embodiments, each template in the plurality of templates may include schemas based on a genre in the plurality of genres. For instance, the schemas may include (but not limited to) Number of acts, plot points, structure of each act (exposition, rising action, climax, falling action, resolution), Narrative structure, chapters, transitions between chapters/acts, images, and so on.

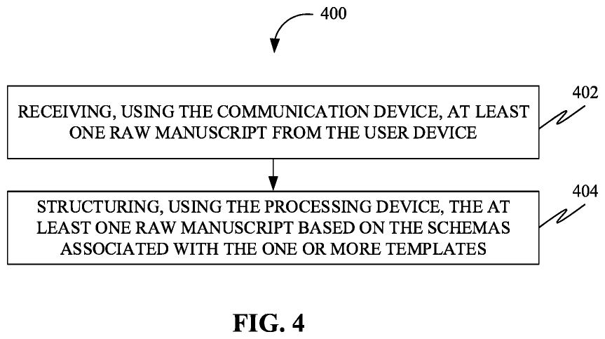

FIG. 4 is a flowchart of a method 400 for facilitating book formatting for a manuscript, in accordance with some embodiments. Accordingly, at 402, the method 400 may include receiving, using the communication device, at least one raw manuscript from the user device.

Further, at 404, the method 400 may include structuring, using the processing device, the at least one raw manuscript based on the schemas associated with the one or more templates.

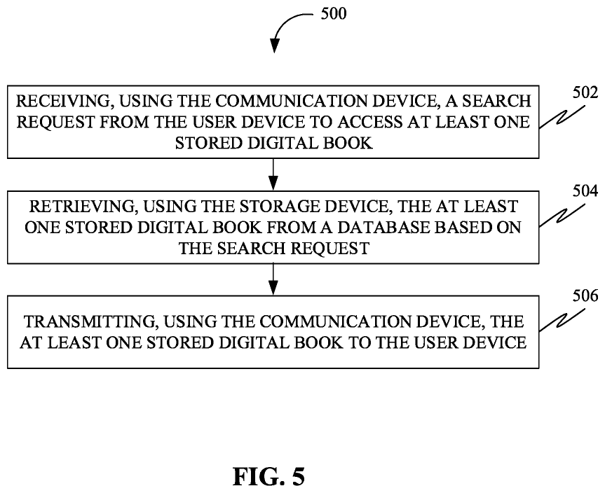

FIG. 5 is a flowchart of a method 500 for facilitating accessing a stored digital book, in accordance with some embodiments. Accordingly, at 502, the method 500 may include receiving, using the communication device, a search request from the user device to access at least one stored digital book. Further, in some embodiments, the at least one stored digital book may include at least one of at least one previously completed digital book, and at least one unfinished digital book.

Further, at 504, the method 500 may include retrieving, using the storage device, the at least one stored digital book from a database based on the search request.

Further, at 506, the method 500 may include transmitting, using the communication device, the at least one stored digital book to the user device.

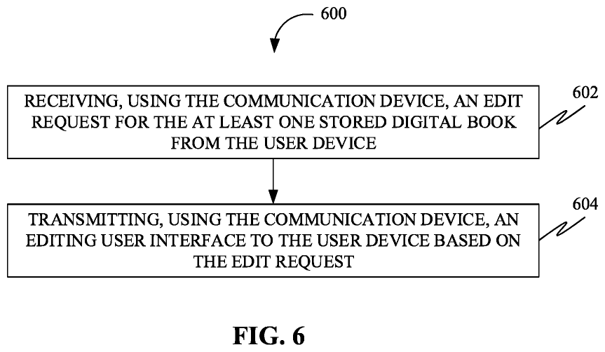

FIG. 6 is a flowchart of a method 600 to facilitate editing a stored digital book, in accordance with some embodiments. Accordingly, at 602, the method 600 may include receiving, using the communication device, an edit request for the at least one stored digital book from the user device. Further, in some embodiments, the at least one stored digital book may include at least one of at least one previously completed digital book, and at least one unfinished digital book.

Further, at 604, the method 600 may include transmitting, using the communication device, an editing user interface to the user device based on the edit request. Accordingly, the user interface, in an instance, may be an interface that may provide one or more editing tools to the user in order to edit a previously completed book file. Further, the user interface, in an instance, may allow the user to edit any section of the previously completed book file, to resave, and/or to extract the previously completed book file.

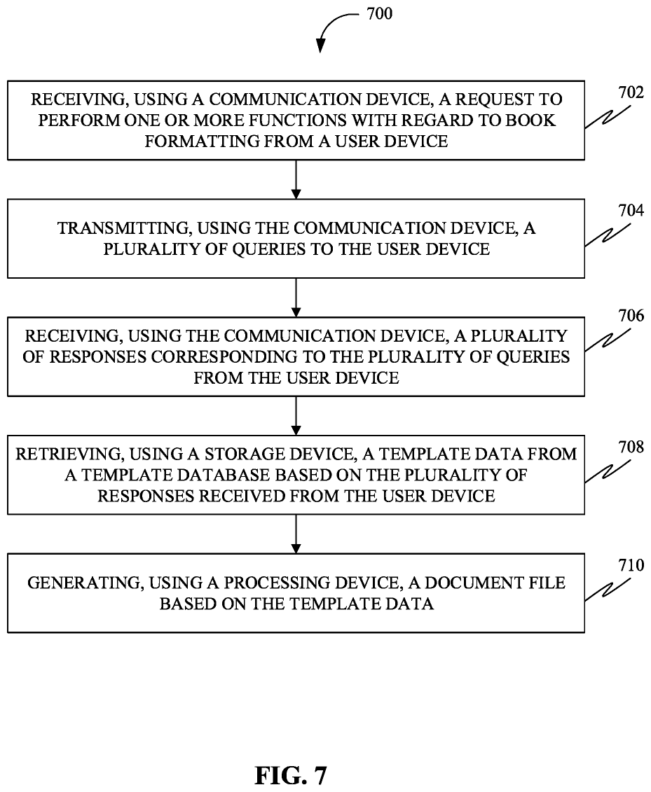

FIG. 7 is a flowchart of a method 700 to facilitate interior book formatting and design for authors, publishers, and other professionals, in accordance with some embodiments. Accordingly, at 702, the method 700 may include a step of receiving, using a communication device (such as the communication device 202), a request to perform one or more functions with regard to book formatting from a user device. For instance, the one or more functions may include, but not limited to, formatting a new book, completing an unfinished book, accessing a completed book, and editing a completed book. Further, the user, in an instance, may provide the request to the online platform 100 through the user device. Further, the user, in an instance, may interact with the user device in order to provide the request. For instance, the user may tap on at least one portion of the user device (such as a section of the user interface associated with the web-based application) in order to provide the request to the online platform 100. In an instance, the user interface may greet the user by displaying a phrase (for instance) “Welcome, Book Emperor! Expand or Bend the world today?” Accordingly, the user, in an instance, may either select “Expand” (which may allow the user to either format a new book, and/or complete an unfinished book) or “Bend” (which may allow the user to either access a completed book, and/or edit the completed book) based on user's requirement. Further, the user device, in an instance, may be devices that may be operated by the user. For instance, the user device may include devices such as, but not limited to, smartphones, computer tablets, laptops, smart watches, and so on.

Further, at 704, the method 700 may include a step of transmitting, using the communication device, a plurality of queries to the user device. Accordingly, the plurality of queries, in an instance, may be questions with regard to formatting and designing of any book that the user may be working on. Further, the plurality of queries, in an instance, may be textual queries that may be presented to the user (through the user interface) using the user device. Further, in some embodiments, the plurality of queries may include one or more options that the user may select as a response to the question. For instance, the plurality of queries may include questions such as, but not limited to, “Select Distributor” having the one or more options (such as names of different distributors) e.g. “IngramSpark,” “LuLu,” “CreateSpace/KDP,” “Lightning Source,” “Baker & Taylor,” “48HourBooks.com,” and/or “I Prefer Vanilla” (no distributor preference/build from blank canvas) (user must then manually set margins, trim size, bleed, and any other distributor setting). Further, in another instance, the plurality of queries may include a query to select a template based on a genre associated with the book that the user may be working on. For example, the query may ask users to “Select Template by Genre” that may be having one or more options e.g. “Sci-Fi,” “Non-Fiction,” “Fantasy,” “Romance,” “Horror/Thriller,” “Teen/Young Adult,” “Action/Adventure,” “Crime/Mystery,” “I Prefer Vanilla” (user must then manually select and insert pages that the user may wish to include). Further, in some embodiments, the plurality of queries may include forms allowing users to enter data. For instance, the plurality of queries may include form such as “Enter International standard book number (ISBN)” where the user may enter the ISBN number. Further, in some embodiments, the plurality of queries may be presented to the user in one or more forms, such as (but not limited to) an audio form, an audiovisual form, a visual form, etc. Further examples of the plurality of queries are described in conjunction with Overview section below.

Further, at 706, the method 700 may include a step of receiving, using the communication device, a plurality of responses corresponding to the plurality of queries from the user device. Accordingly, the plurality of responses, in an instance, may be any user input from the user device as a reply to the plurality of queries. For instance, the plurality of responses may include a user selecting at least one option from the one or more options associated with the plurality of queries. For example, for a query such as “Select Book Format” with the one or more options such as “Paperback,” “Hardback,” and “eBook,” the user may select at least one option from the one or more option by interacting with the user interface through the user device. Further, the plurality of responses, in an instance, may include a user providing a textual data as a response to a query. For example, for a query such as “Enter Book Title,” the user may provide a title of a book by interacting with the user device (such as providing the title by using a keyboard associated with a laptop/smartphone). Further, in some embodiments, the user may provide a multimedia data as a response to the plurality of queries. For instance, the user may provide (and/or upload) the multimedia content (such as an image of a book logo) in response to a query (e.g. enter book title). Further, the multimedia content, in an instance, may be any content in a digital form that the user may wish to provide as a response to the plurality of queries. Further, the multimedia content may include, but is not limited to, one or more of audio content, video content, textual content, and sensor data. Further, the multimedia content may be captured by one or more content capturing devices such as, but not limited to, a camera, a microphone and one or more sensors configured to capture physical, chemical and/or biological variables. Further, the multimedia content may be stored in one or more storage devices such as but not limited to, semiconductor memory, magnetic storage, etc. Further, the one or more content capturing devices and the one or more storage devices, in an instance, may be embedded within the user device.

Further, in some embodiments, the plurality of queries may be transmitted to the user device in a sequential order. Further, the sequential order, in an instance, may be based on the plurality of responses received from the user device. Further, the sequential order, in an instance, may include one by one provisioning of queries to the user device. For instance, the user may provide a response for one query at a time, with a next query to be dependent on the response received from the user device for previous queries.

Further, at 708, the method 700 may include a step of retrieving, using a storage device (such as the storage device 206), a template data from a template database based on the plurality of responses received from the user device. Accordingly, the template data, in an instance may include one or more presets and/or templates that may be used for interior book formatting and designing. Further, the one or more presets and/or templates, in an instance, may be fully editable templates that may assist authors, publishers, and/or other professionals with the interior book formatting. Further, the template data, in an instance, may be stored in the template database that may be electronically accessible to the online platform 100. Further, the template database, in an instance, may be configured to store the one or more presets and/or templates in an organized form. For instance, the one or more presets and/or templates may be tagged with one or more keywords that may allow the online platform 100 to identify at least one template based on the plurality of responses received from the user device. Further, the online platform 100, in an instance, may analyze (such as using the processing device 204) the plurality of responses to determine the one or more presets and/or templates for the user. Further, in some embodiments, the one or more presets and/or templates may be mapped with the one or more options of the plurality of queries. For instance, when the user may select an option from the one or more options as response a query, then the one or more presets and/or templates that may be mapped with the option may be used for the interior book formatting and designing.

Further, at 710, the method 700 may include a step of generating, using the processing device, a document file based on the template data. Accordingly, the document file, in an instance, may be a formatted pdf and/or a word file that may be extracted and/or may adhere to distributor guidelines. Further, the user interface, in an instance, may allow the user to save and extract the document file. For instance, the user may store the document file to software archive (e.g. database 108). Further, the user may extract the document file in order to save the document file to other drives.

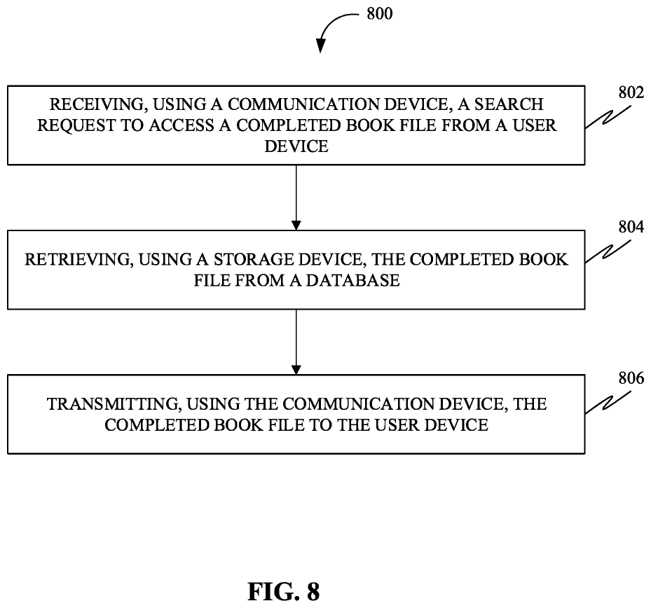

FIG. 8 is a flowchart of a method 800 to facilitate viewing previously completed book, in accordance with some embodiments. Accordingly, at 802, the method 800 may include a step of receiving, using a communication device (such as the communication device 202), a search request to access a completed book file from a user device. Further, the completed book file, in an instance, may be any previously formatted pdf and/or word file that may be formatted (and/or saved) by the user through the online platform 100. Further, the completed book file, in an instance, may be any previously formatted pdf and/or word file that the user may wish to access for viewing. Further, the user, in an instance, may provide the search request by interacting with the user device. Further, the user device, in an instance, may be IoT based devices that may be configured to communicate with the online platform 100. For instance, the user device may include devices such as, but not limited to, smartphones, computer tablets, laptops, smart watches, and so on.

Further, at 804, the method 800 may include a step of retrieving, using a storage device (such as the storage device 206), the completed book file from a database. Accordingly, the database (such as databases 108), in an instance, may be an archive configured to store a collection of previously completed book files in an organized form. Further, the collection of previously completed book files, in an instance, may be accessed electronically from the database by the online platform 100.

Further, at 806, the method 800 may include a step of transmitting, using the communication device, the completed book file to the user device. Accordingly, the online platform 100, in an instance, may be configured to transmit the completed book file to the user device through a wireless transmitter. The wireless transmitter, in an instance, may transmit the completed book file over, but not limited to, a Wi-Fi, a Bluetooth, an electromagnetic waveform, ultra-sound, cellular (5G) and/or an Infra-red, etc.

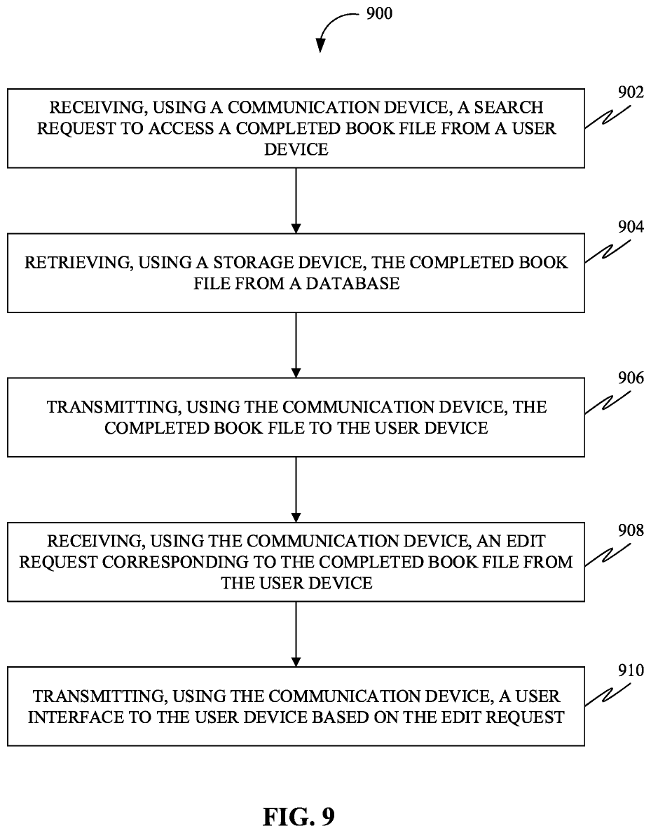

FIG. 9 is a flowchart of a method 900 to facilitate editing a previously completed book, in accordance with some embodiments. Accordingly, at 902, the method 900 may include a step of receiving, using a communication device (such as the communication device 202), a search request to access a completed book file from a user device. Further, the completed book file, in an instance, may be any previously formatted pdf and/or word file that may be formatted (and/or saved) by the user through the online platform 100. Further, the completed book file, in an instance, may be any previously formatted pdf and/or word file that the user may wish to access for editing. Further, the user, in an instance, may provide the search request by interacting with the user device. Further, the user device, in an instance, may be IoT based devices that may be configured to communicate with the online platform 100. For instance, the user device may include devices such as, but not limited to, smartphones, computer tablets, laptops, smart watches, and so on.

Further, at 904, the method 900 may include a step of retrieving, using a storage device, the completed book file from a database. Accordingly, the database (such as databases 108), in an instance, may be an archive configured to store a collection of previously completed book files in an organized form. Further, the collection of previously completed book files, in an instance, may be accessed electronically from the database by the online platform 100.

Further, at 906, the method 900 may include a step of transmitting, using the communication device, the completed book file to the user device. Accordingly, the online platform 100, in an instance, may be configured to transmit the completed book file to the user device through a wireless transmitter. The wireless transmitter, in an instance, may transmit the completed book file over, but not limited to, a Wi-Fi, a Bluetooth, an electromagnetic waveform, ultra-sound, cellular (5G) and/or an Infra-red, etc.

Further, at 908, the method 900 may include a step of receiving, using the communication device, an edit request corresponding to the completed book file from the user device.

Further, at 910, the method 900 may include a step of transmitting, using the communication device, a user interface to the user device based on the edit request. Accordingly, the user interface, in an instance, may be an interface that may provide one or more editing tools to the user in order to edit the completed book file. Further, the user interface, in an instance, may allow the user to edit any section of the completed book file, to resave, and/or to extract the completed book file.

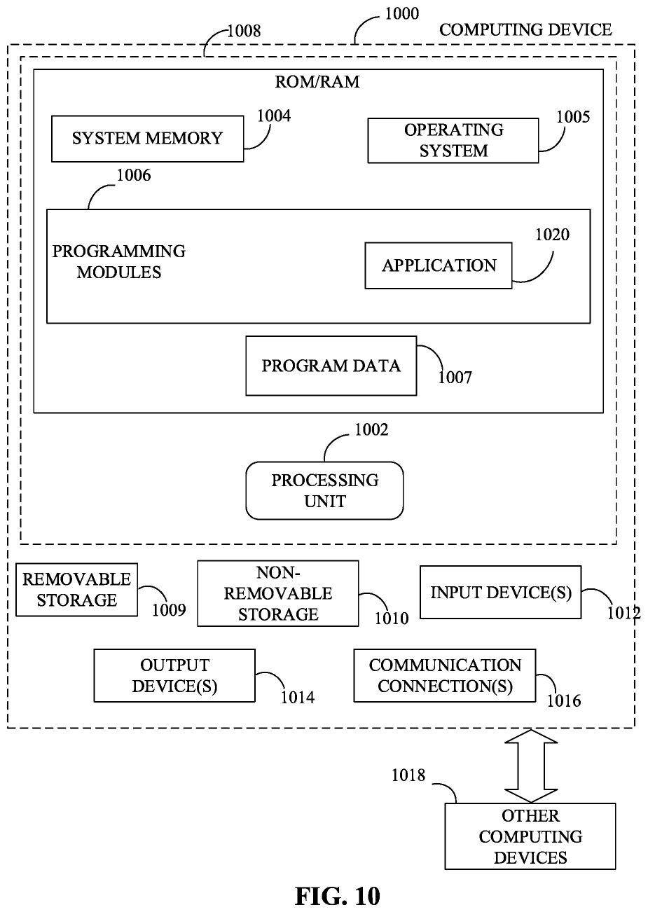

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and non-volatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

### Overview:

The present disclosure includes systems and methods to facilitate interior book formatting and design for authors, publishers, and other professionals. Further, the present disclosure includes Emper. Further, the Emper is a step-by-step software program with hundreds of preset and fully editable templates that assists authors, publishers, and other professionals with interior book formatting. The Emper may generate the proper interior based on selections made by the user. The Emper may generate a formatted PDF and/or Word file for extraction that adheres to distributor guidelines.

STEP-BY-STEP FUNCTIONS (Emper may autosave after each selection)
Emper opening: Emper logo with licensing info, version, etc.
First time startup: Software registration
Emper greeting: “Welcome, Book Emperor!” “Expand or Bend the world today?”
IF EXPAND:
a.)Awaken (Format New Book)
b.)Share (Complete Unfinished Book)
IF BEND:
a.) Relive (Archives/Access Completed Book)
b.) Upgrade (Edit Completed Book)

Further, the Emper may include Core Options such as (but not limited to) Format New Book (Awaken Your Vision), Archives/Access Completed Book (Relive Your Vision), Complete Unfinished Book (Share Your Vision), Edit Completed Book (Upgrade Your Vision).

Further, for Format New Book, the user may be asked following queries.
1.) Select Distributor
   a.) IngramSpark
   b.) LuLu
   c.) CreateSpace/KDP
   d.) Lightning Source
   e.) Baker & Taylor
   f.) 48HourBooks.com (no publishing services offered)
   g.) I Prefer Vanilla (no distributor preference/build from blank canvas) (user must then manually set margins, trim size, bleed, and any other distributor setting)
2.) Select Template by Genre (templates also include chapter break images)
   a.) Sci-Fi (10 design templates) (See template names below)
   b.) Non-Fiction (3 to 5 design templates) (See template names below)
   c.) Fantasy (10 design templates) (See template names below)
   d.) Romance (10 design templates) (See template names below)
   e.) Horror/Thriller (5 to 10 design templates) (See template names below)
   f.) Teen/Young Adult (10 design templates) (See template names below)g.)
   Action/Adventure (3 to 5 design templates) (See template names below)
   h.) Crime/Mystery (3 to 5 design templates) (See template names below)
   i.) I Prefer Vanilla (no template/build from blank canvas) (user must then manually select and insert pages they'd like to include)
3.) Select Book Format
   a.) Paperback
   b.) Hardback
   c.) eBook (coming soon!) (leave backdoor open for this function to be added later)
4.) Select Trim/Book Size (if distributor doesn't support the size, it shouldn't appear here) (paperback trim sizes) (IngramSpark is used for this model)
   4×6″ (154×102 mm)
   4×7″ (178×102 mm)
   4.25×7″ (178×108 mm)
   4.37×7″ (178×111 mm) A
   4.72×7.48″ (190×120 mm)
   5×7″ (178×127 mm)
   5×8″ (203×127 mm)
   5.06×7.81″ (198×129 mm)
   5.25×8″ (203×133 mm)
   5.5×8.25″ (210×140 mm)
   5.5×8.5″ (216×140 mm)
   5.83×8.27″ (210×148 mm) A5
   6×9″ (229×152 mm)
   6.14×9.21″ (234×156 mm)
   6.5×6.5″ (165×165 mm)
   6.625×10.25″ (260×168 mm) (Graphic Novel)
   6.69×9.61″ (244×170 mm) (Pinched Crown)
   7×10″ (254×178 mm)
   7.44×9.69″ (246×189 mm)
   7.5×9.25″ (235×191 mm)
   8×8″ (203×203 mm)
   8×10″ (254×203 mm)
   8×10.88″ (276×203 mm)
   8.25×10.75″ (273×210 mm)
   8.25×11″ (279×210 mm)
   8.268×11.693″ (297×210 mm) A4
   8.5×8.5″ (216×216 mm)
   8.5×9″ (229×216 mm)
   8.5×11″ (280×216 mm)
   Custom size (if selected, a warning notice should appear “Warning, most distributors do not accept and may not publish custom sizes. To proceed, click ok.”)
(hardback trim sizes) (IngramSpark is used for this model)
   5×8″ (203×127 mm) Case Lam/Cloth/Dust Jacket
   5.5×8.5″ (216×140 mm) Case Lam/Cloth/Dust Jacket
   5.83×8.27″ (210×148 mm) Case Lam
   6×9″ (229×152 mm) Case Lam/Cloth/Dust Jacket
   6.14×9.21″ (234×156 mm) Case Lam/Cloth/Dust Jacket
   6.69×9.61″ (244×170 mm) Case Lam
   7×10″ (254×178 mm) Case Lam
   7.5×9.25″ (235×191 mm) Case Lam
   8×8″ (203×203 mm) Case Lam
   8×10″ (254×203 mm) Case Lam
   8×10.88″ (276×203 mm) Case Lam
   8.25×10.75″ (273×210 mm) Case Lam
   8.5×8.5″ (216×216 mm) Case Lam
   8.5×11″ (280×216 mm) Case Lam
5.) Enter ISBN Number
   a.) If you require an ISBN, please click here to purchase from Bowker Identifier Services. You may purchase your ISBN from any ISBN seller.
6.) Enter book title (mandatory)
   a.) Upload book logo (optional)
7.) Enter subtitle (optional)
8.) Enter author's name (mandatory)
   a.) Upload author logo (optional)
9.) Enter co-author's name (optional)
10.) Enter name of publisher or imprint (mandatory)
   a.) Enter publisher contact information (optional space for website link, address)
11.) Include publisher logo? (optional)
   a.) If yes, upload image (automatically resize it on the copyright page)
12.) Enter Edition of book (mandatory)
   a.) First Edition, Second Edition, etc.
   b.) Custom input
13.) Enter name of editor (optional)
14.) Enter name of interior formatter/typesetter (optional, but may include “using Emper Technologies, LLC” tag)
15.) Enter copyright owner's name (mandatory)
   a.) Is copyright owner same as author name?
   b.) If yes is selected, automatically apply this name to the copyright page
16.) Year of copyright (mandatory)
17.) Include standard copyright verbiage? (optional)
   a.) If yes, insert: “All rights reserved. No part of this publication may be reproduced, distributed, or transmitted in any form or by any means, including photocopying, recording, or other electronic or mechanical methods, without the prior written permission of the publisher, except in the case of brief quotations embodied in critical reviews and certain other noncommercial uses permitted by copyright law. For permission requests, write to the publisher, addressed “Attention: Permissions Coordinator,” at the address below.”
   b.) If no, insert custom copyright verbiage.
18.) Enter cover art designer name (mandatory)
   a.) Include sections for multiple designer names
19.) Additional credits? (optional)
   a.) Include sections for additional contributors
20.) Select Table of Contents Template (mandatory)
21.) Include author acknowledgment/note page? (optional)
   a.) If yes, enter wording
22.) How many numbered book chapters? (mandatory)
   a.) Additional chapters can be added later
23.) Numbered Chapter titles? (optional)
   a.) If yes, enter sections for user to type the names of their numbered chapters
   b.) If no, user may customize their chapters by word lettering
24.) Include Prologue or Preface? (optional)
   a.) If yes, enter wording
25.) Include other leading pages? (optional)
   a.) If yes, enter wording
   b.) If yes, enter image (can be inserted later)
26.) Include Epilogue? (optional)
   a.) If yes, Emper should auto-insert this template page at after the ending of the last numbered book chapter
28.) Include “Upcoming” or “Next” page for series books? (optional)
   a.) If yes, Emper should auto-insert this template page after the epilogue or last numbered chapter (if no epilogue)
29.) Include “Other Works By Author” page” (optional)
   a.) If yes, allow user to select where to insert page in the book
30.) Include other Custom informational page?
   a.) If yes, allow user to select where to insert this custom page and allow user to name the layout of the custom page for future use in other books

Further, once all selections have been made, Emper may open its main working space (may be referred to as Lecktrum Dashboard), with clickable links on the left of the screen that allow the user to jump from page to page as needed.
31.) Take User to numbered Chapters where they can manually type wording, import from Word, or manually copy and paste it in from a different program. Either selection, Emper should automatically insert proper paragraph indentions. Software should auto-detect blank lines and auto-insert chapter break images accordingly.

Further, user may move from chapter to chapter, inserting their data. Further, the users should be allowed to insert and change images as they move along.
32.) User may now jump from screen to screen, putting their final touches on all their pages.
33.) “VIEW”: There should be a clickable “view” button at the top of the Lecktrum Dashboard that allows users to pre-view their book in PDF format at any time.
   a.) Allow user to view their book in a side-by-side page, book viewing mode.
34.) “DONE”: There should be a clickable green “done” button at the top of the Lecktrum Dashboard that remains grayed out until user has visited every page in the book.
   a.) When clicked, move user to Spell Check
35.) Perform Spell Check (mandatory)
   a.) After user has corrected or ignored any spell check alerts, move user to Assemble/Compile function
36.) Assemble/Compile Book (Emper may generate editable Word and PDF files for extraction)
SUCCESS PAGE: You've successfully awakened your vision!
37.) SAVE AND EXTRACT
   a.) Allow user to save book to software archive
   b.) Allow user to extract Word and PDF files and save them to other drives
   Options: Format New Book (Awaken Your Vision)
Archives/Access Completed Book (Relive Your Vision)
Complete Unfinished Book (Share Your Vision)
Edit Completed Book (Upgrade Your Vision)

Further, Archives/Access Completed Book may include.
1.) Select Completed Book
   a.) Allow user to view previously completed book
   b.) Allow user to re-extract previously completed book
   c.) If user wishes to edit, take them to the Edit Completed Book Function
SUCCESS PAGE: You've successfully Relived your vision!
   Options: Format New Book (Awaken Your Vision)
Archives/Access Completed Book (Relive Your Vision)
Complete Unfinished Book (Share Your Vision)
Edit Completed Book (Upgrade Your Vision)
Complete Unfinished Book
1.) Select Unfinished Book
   a.) Once selected, take user through uncompleted Format New Book functions
   b.) Allow user to pick up where they left off
SUCCESS PAGE: You've successfully Shared your vision!
   Options: Format New Book (Awaken Your Vision)
Archives/Access Completed Book (Relive Your Vision)
Complete Unfinished Book (Share Your Vision)
Edit Completed Book (Upgrade Your Vision)
   Edit Completed Book
1.) Select Book
   a.) Allow user to edit any section of previously completed book, resave, and extract
   b.) Uncompleted books may appear under the Complete Unfinished Book function
SUCCESS PAGE: You've successfully Upgraded your vision!

Further, Software should auto-link to Emper at startup to verify authenticity of license. Once single-user license number has been entered for device, software cannot be activated on another device using same license number unless user logs into their online Emper account and deactivate current device. If user loses disc, they may download Emper from website, but must still deactivate and reactivate device for single-device license. If single user loses activation license number from CD ROM, user must purchase new license. If user loses activation license number from online download purchase, license number is retrievable through their online account.

Users must purchase multiple-use license for use on multiple devices, for one user. Or user may purchase multiple-user license for multiple device/user.
Further, the system may include EMPER'S ATHANAEUM (Library of Templates). Further, the EMPER'S ATHANAEUM may include following templates based on different genre.
Sci-Fi (design templates)
   1.Gutter
   2.Reef
   3.Meta
   4.Invasion
   5.Bio-Flow
   6.Replicas
   7.Misanthrope
   8.Temerity
   9.Terraform
Non-Fiction (design templates)
   1.Slope
   2.Rustic
   3.Dutch
   4.Commando
Fantasy (10 design templates)
   1.High Low Go
   2.Virtuoso (Witchcraft and Wizardry)
   3.Wayfare (Interstellar travel)
   4.Dream-Me
   5.Versus
   6.SteelCuts (Sword)
   7.Anthropocene
   8.Palladium
   9.Necropolis (Dystopian)
   10.Biophilia (apocalyptic)
Romance (10 design templates)
   1.PlumbTree
   2.Crushes
   3.Sticky Sweet
   4.Never-Die
   5.HEA
   6.Opus
   7.Haciendas
   8.Mistress
   9.Sirenic
   10.Doucer
   11.Neoteric (Modern Contemporary)
   12.Mulligrubs (Southern)
Horror/Thriller (5 to 10 design templates)
   1.Sliced
   2.Silhouetted
   3.Sanguine
   4.Stabby
   5.Eere
   6.Sphinx
   7.Timorous
Teen/Young Adult (10 design templates)
   1.Saccharine Dream
   2.Fang & Dagger
   3.Anti
   4.Obvious
   5.Bonds, Binds, and Bounds
   6.Filtered Foes
   7.Rotten Pilgrimage
   8.Introspection
   9.Breezy
   10.Stripling Rippling
   11.Alacrity
   12.Adultescent
Action/Adventure (3 to 5 design templates)
   1.Leapings
   2.Adrenaline Junkie
   3.Ataxia
   4.Trudge
   5.Interloper
Crime/Mystery (3 to 5 design templates)
   1.X
   2.Prober
   3.Spect
   4.Summarize
   5.Unknown Unknowns
   6.Phatic
   7.Keek
   8.Scienter
   9.Volute

Further, the present disclosure includes lecktrum workspace dashboard. Further, workspace functions may include top screen clickable link functions, Left screen clickable link functions, and top screen drop down menu functions.
Further, the Top screen clickable link functions may include:
   1. Add additional chapter
   2. Remove chapter
   3. Change template
   4. File/register copyright (link to eCO)
   5. Delete pages/Rearrange page order
   6. Retitle Book
   7. Delete Current Book/Start Over
   8. Start New/Save
   9. Image Gallery (upload)
   10. Font Gallery (upload)
   11. Change distributor
   12. VIEW
   13. DONE (compile/extract) warning: if user edits files after extraction, formatting may no longer adhere to distributor requirements.
   14. Resource links
   15. Updates
Further, Left screen clickable link functions, featuring “drag & drop” to rearrange pages feature:
   Lead Page
   Title Page
   Copyright Page
   Foreword
   Author Acknowledgements
   Preface
   Prologue
   Chapter 1
   Chapter 2
   Chapter 3
   Chapter 4
   Chapter 5
   Chapter 6
   Chapter 7
   Chapter 8
   Chapter 9
   Chapter 10
   Chapter 11
   Chapter 12
   Chapter 13
   Chapter 14
   Chapter 15
   Chapter 16
   Chapter 17
   Chapter 18
   Chapter 19
   Chapter 20
   Epilogue
   Coming Soon
   Publisher/Author Contact Page
Further, top screen drop down menu functions
   Get ISBN
   Visit Athenaeum (Online Template Store)
   Software Updates
   Import
   Export
   Upgrade Software
   Sign In/Manage Account (Online Account)
Further, software, in an instance, may include four versions named (for instnace) Vital, Yen, Bossem, and Honcho.

Vital is the Basic version, including one seat, one license, one-use, on one device. This version may be intended for self-publishers.

Yen is the Intermediate version, including two seats, one license, on two devices. This version may be intended for small indie publishers.

Bossem is the Professional version, including five seats, 5 licenses, on up to 5 devices. This version may be intended for medium size publishers.

Honcho is the Enterprise version, including 15 seats, 15 licenses on up to 15 devices. This version may be intended for large publishers and is expandable to suit the needs of each publishing house.

Further, in some embodiments, Emper is a step-by-step software program with hundreds of preset and fully editable templates that assists authors, publishers, and other professionals with interior book formatting. The software generates the proper interior based on selections made by the user. The software may generate a formatted PDF and/or Word file for extraction that adheres to distributor guidelines. Both may remain fully editable.

Pricing: Structure may be determined based on cost of development. Additional template packages can be purchased separately, as add-ons to main software. Basic (Vital), Intermediate (Yen), Pro (Bossem), Enterprise (Honcho) versions are leveled by number of users/devices and features.

Further, the system may include API integration to link with distributors for updates etc. Further, list of page types to format may include:
title page
copyright page
dedication/acknowledgement page
table of contents
forward
preface
epilogue
chapter heading pages
upcoming books page/other author works
contact information page
blank page
Further, fully customizable features may include:
   chapter headings
   book size
   page borders
   bleeds and margins
Further, templates may include:
   Ability to duplicate a previous book format completed with Emper
   Page numbers
   Headers
   Footers
   Font
   Chapter titles
   Images
   Size (6×9 etc)
   Distributor (Ingram, Baker & Taylor, Lightning Source, CreateSpace/KDP, Lulu, none, etc)

Create TEMPLATE names that represent popular genres, including blank.
Further, following is a list of resources to integrate:
   link to bowker for isbn numbers and barcodes
   library of congress eco (electronic copyright page)
   link to kdp for account setup
   link to amazon's author central
   link to lulu
   link to ingramspark
   link to kobo
   link to apple
   link to goodreads
   link to ebook formatting companies (advertising for a fee)
   link to kirkus (advertising for a fee)
Further, following is a list of preset/customizable pages:

pre-title/introductory page: Allow user to enter the title of the book, with an option of including the author name and an image. The software should have preset images and blurring tools that allow the user to design the title page to look professionally appealing.

Title Page: Allow user to enter the title of the book, with an option of including the author name and an image. The software should have preset images and blurring tools that allow the user to design the title page to look professionally appealing.

Coyright Page: The software functions should be a step-by-step process that asks the user to enter data into the proper fields (i.e. book title, book subtitle, author name, additional author name, publisher/imprint, book cover designer, book interior formatter, website information, year of copyright, copyright owner name, ISBN, version of book, edition of book). Allow user to insert images anywhere on the page. This function should also automatically insert copyright protection verbiage, which is fully editable, and appear on a separate screen as the user moves through the functions.

Table Of Contents: The general template should be visible during the formatting process to allow the user to insert images on-screen. This feature should be carefully crafted to only fully generate after the entire book has been inputted into the software and a final (but still editable) version of the book is generated. This is to ensure that the chapter heading titles and page numbers match up. However, the software should also offer several different preset templates to choose from that does not have to fall in line with a previously selected template.

Further, as a summary, a software application that takes a manuscript and formats it into pages, based on the size book the writer selects. Software should also have user-friendly features that allow the user to customize chapter titles and properly insert images anywhere in the book while maintain the proper format and margins. Software should include thousands of included fonts but allows users to import fonts as well. Features should include, designating any page to format accordingly (title page, copyright page, standard book page, table of contents, etc). The software should have the ability to allow self-publishers and others to professionally format a book from starting page to last page. Specifications should include preset orientations based on distributor preferences (IngramSpark, Lightning Source, CreateSpace, Lulu etc.).

Further, the system may include a demo mode, wherein each user must be required to create and account but may only be able to use the software tool for free for 7 days. However, while in demo mode, the software may not generate usable or extractable Word and PDF files. The software should only generate viewable files to show the user what their files may look like if they purchase the complete software. There may be payment involved with using our platform.

Further, Emper may ultimately be an offline and online process. To start out, Emper may be focused on the hard copy (which should also be downloadble) that controls everything (including the online process). In the future, users may select the cloud (online version), the downloadable (hard copy) or a CD ROM hard disc.

Further, Emper may be pre-programmed with each distributors margin, gutter, and bleed requirements but also layered with design templates. So, a distributor setting as the foundation for any design template Emper has preprogrammed into it.

For example, LuLu requires their PDF files to include a bleed, but the average user may not know anything about bleeds nor how to program their PDF file to the proper setting. We require the developer to gather this information by contacting LuLu and all other distributors for the proper information to program into the software. There are many examples to use. Such as, image resolution requirements with IngramSpark. PDF/A requirements, etc.

For example: When the user opens Emper and begins their formatting journey, the software may ask “Which Distributor are you formatting for?” The user makes a selection from the preset list. Let's say that the user may select IngramSpark. The software may then auto-populate IngramSpark's foundational settings. The user may then continue on to the next function of selecting book size, design template, etc.

1. A method for facilitating book formatting, wherein the method comprises:
providing a communication device, a processing device and a storage device;
receiving, using the communication device, a request to perform one or more book formatting operations from a user device;
transmitting, using the communication device, a plurality of queries to the user device based on the request;
receiving, using the communication device, a plurality of responses corresponding to the plurality of queries from the user device, wherein the plurality of queries comprise a textual query, a visual query, an audio query and an audiovisual query, wherein the plurality of responses comprise a textual input, an audible input and a multimedia input;
analyzing, using the processing device, the plurality of responses to identify one or more templates in a plurality of templates stored in a template database;
retrieving, using the storage device, the one or more templates from the template database based on the analyzing; and
generating, using the processing device, a distributor ready digital book based on the one or more templates.

2. The method of claim 1, wherein the one or more book formatting operations comprise at least one of formatting a book, completing a book, accessing a book, and editing a book.

3. (canceled)

4. The method of claim 1, wherein the transmitting of the plurality of queries is based on a predefined sequential order.

5. The method of claim 1, wherein the template database comprises the plurality of templates based on a plurality of genres.

6. The method of claim 5, wherein each template in the plurality of templates comprises schemas based on a genre in the plurality of genres.

7. The method of claim 6, wherein the method further comprising:
receiving, using the communication device, at least one manuscript from the user device; and
structuring, using the processing device, the at least one manuscript based on the schemas associated with the one or more templates.

8. The method of claim 1 further comprising:
receiving, using the communication device, a search request from the user device to access at least one stored digital book;
retrieving, using the storage device, the at least one stored digital book from a database based on the search request; and
transmitting, using the communication device, the at least one stored digital book to the user device.

9. (canceled)

10. The method of claim 8 further comprising:
receiving, using the communication device, an edit request for the at least one stored digital book from the user device; and
transmitting, using the communication device, an editing user interface to the user device based on the edit request.

11. A system for facilitating book formatting, wherein the system comprises:
a communication device;
a processing device;
a storage device;
wherein the communication device receives a request to perform one or more book formatting operations from a user device;
wherein the communication device transmits a plurality of queries to the user device based on the request;
wherein the communication device receives a plurality of responses corresponding to the plurality of queries from the user device, wherein the plurality of queries comprise a textual query, a visual query, an audio query and an audiovisual query, wherein the plurality of responses comprise a textual input, an audible input and a multimedia input;
wherein the processing device analyzes the plurality of responses to identify one or more templates in a plurality of templates stored in a template database;
wherein the storage device retrieves the one or more templates from the template database based on the analyzing; and
wherein the processing device generates a distributor ready digital book based on the one or more templates.

12. The system of claim 11, wherein the one or more book formatting operations comprise at least one of formatting a book, completing a book, accessing a book, and editing a book.

13. (canceled)

14. The system of claim 11, wherein the transmitting of the plurality of queries is based on a predefined sequential order.

15. The system of claim 11, wherein the template database comprise the plurality of templates based on a plurality of genres.

16. The system of claim 15, wherein each template in the plurality of templates comprises schemas based on a genre in the plurality of genres.

17. The system of claim 16, wherein the communication device receives at least one manuscript from the user device, and wherein the processing device structures the at least one manuscript based on the schemas associated with the one or more templates.

18. The system of claim 11, wherein the communication device receives a search request from the user device to access at least one stored digital book, wherein the communication device transmits the at least one stored digital book to the user device, and wherein the storage device retrieves the at least one stored digital book from a database based on the search request.

19. (canceled)

20. The system of claim 18, wherein the communication device receives an edit request for the at least one stored digital book from the user device, and wherein the communication device transmits an editing user interface to the user device based on the edit request.
